(19) United States
(12) Patent Application Publication
(10) Pub. No.: US 2008/0280471 A1
(43) Pub. Date: Nov. 13, 2008

(54) Sequencing connection device

(75) Inventor: Marcelo Alejandro Perez, Franklin, TN (US)

Correspondence Address: SCHNEIDER ELECTRIC / SQUARE D COMPANY;LEGAL DEPT. - I.P. GROUP (NP), 1415 S. ROSELLE ROAD, PALATINE, IL, 60067, US

(73) Assignee: Square D Company

(21) Appl. No.: 11/801,730

(22) Filed: May 10, 2007

(51) Int. Cl. H01R 13/64

(52) U.S. Cl. 439/248; 29/857

(57) ABSTRACT

A connection device for preparing multiple electrical wires for connection to terminals includes multiple wire adapters each of which is shaped and dimensioned to fit onto one of the wires. A top shell forms multiple recesses each of which is adapted to receive at least a portion of one of the wire adapters, and a bottom shell adapted to enter into engagement with the top shell secures the wire adapters within the recesses in the top shell when the top and bottom shells are engaged with each other to prevent movement of the wires and wire adapters relative to the shells. A fastener locks the shells together with the wire adapters in the recesses.

### FIELD OF THE INVENTION

The present invention relates generally to a multi-wire connection device for facilitating the connection of multiple wires to multiple terminals. More specifically, the present invention relates to a multi-wire clip for pre-making wire harnesses for screw terminal blocks.

### BACKGROUND OF THE INVENTION

Connections to existing electrical meters are typically either screw terminals or plug-in connectors. Screw terminals have the inconvenience of losing the wire sequence if the wires have to be removed. Technicians have to search for the right sequence before connecting the wires again after the meter has been replaced. Another limitation of the screw terminals is that the creation of wire harnesses ahead of the installation is not a real benefit, since time has to be spent to match the wires to the correct position. Plug-in connectors are a better solution when a wire harness is to be made ahead of the installation. In fact, it is a common practice among panel builders and OEMs to pre-make wire harnesses to reduce installation time.

Plug-in connectors are considerably more expensive than screw terminals, which limits their use to high-end devices. In addition, plug-in connectors are typically larger than screw terminal with similar electrical characteristics. In today's compact electrical devices, reduction of physical size is often a key benefit for the customer.

What is needed, therefore, is a space-efficient and cost-effective multi-wire connection device for facilitating the connection of multiple wires to multiple terminals. More specifically, there is a need for a multi-wire clip for pre-making wire harnesses for use with screw terminal blocks.

### SUMMARY OF THE INVENTION

In one specific embodiment, identifying indicia are associated with each of the recesses for identifying each of the wires in the wire adapters in the recesses. The identifying indicia may be in the form of letters, numbers, symbols, shapes and/or colors, most of which can be formed by raised or recessed portions of an exterior surface of at least one of the shells.

In one specific embodiment, identifying indicia are associated with each of the recesses for identifying each of the wires in the wire adapters in the recesses. The identifying indicia may be in the form of letters, numbers, symbols, shapes and/or colors, most of which can be formed by raised or recessed portions of an exterior surface of at least on of the shells.

In one implementation, the recesses that receive the wire adapters are open on one side to expose portions of the wire adapters for engagement by the bottom shell. The fastener that locks the shells together can be formed by mating clips and sockets formed as integral parts of the shells.

The foregoing and additional aspects of the present invention will be apparent to those of ordinary skill in the art in view of the detailed description of various embodiments, which is made with reference to the drawings, a brief description of which is provided next.

### BRIEF DESCRIPTION OF THE DRAWINGS

The foregoing and other advantages of the invention will become apparent upon reading the following detailed description and upon reference to the drawings.

FIG. 1 is perspective view of one embodiment of a multi-wire connection device utilizing the present invention.

FIG. 2 is an enlarged, exploded perspective view of the device of FIG. 1.

FIG. 3 is a plan view of a connection between the connection device of FIG. 1 and a terminal module.

FIG. 4 is a perspective view of the connection shown in FIG. 3.

### DETAILED DESCRIPTION OF THE ILLUSTRATED EMBODIMENTS

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

The sequencing connection device of the invention, which may also be referred to as a multi-wire clip (MWC), introduces a new way of wiring. The sequencing connection device brings the capability of pre-making wire harnesses with screw terminal blocks. Wires can be configured in advance to match the sequence of the connections. This sequence of wires will be maintained even when the connection is removed from the screw terminal. Thus, the sequencing connection device can be applied to many situations where the sequence of connection to a terminal has to be maintained including electrical wiring, compressed air/gas hoses going into a manifold and fiber optics connections. In addition, the sequencing connection device is an inexpensive solution that can brings a 30% cost reduction in the total cost of connections to a meter compared to a plug-in solution.

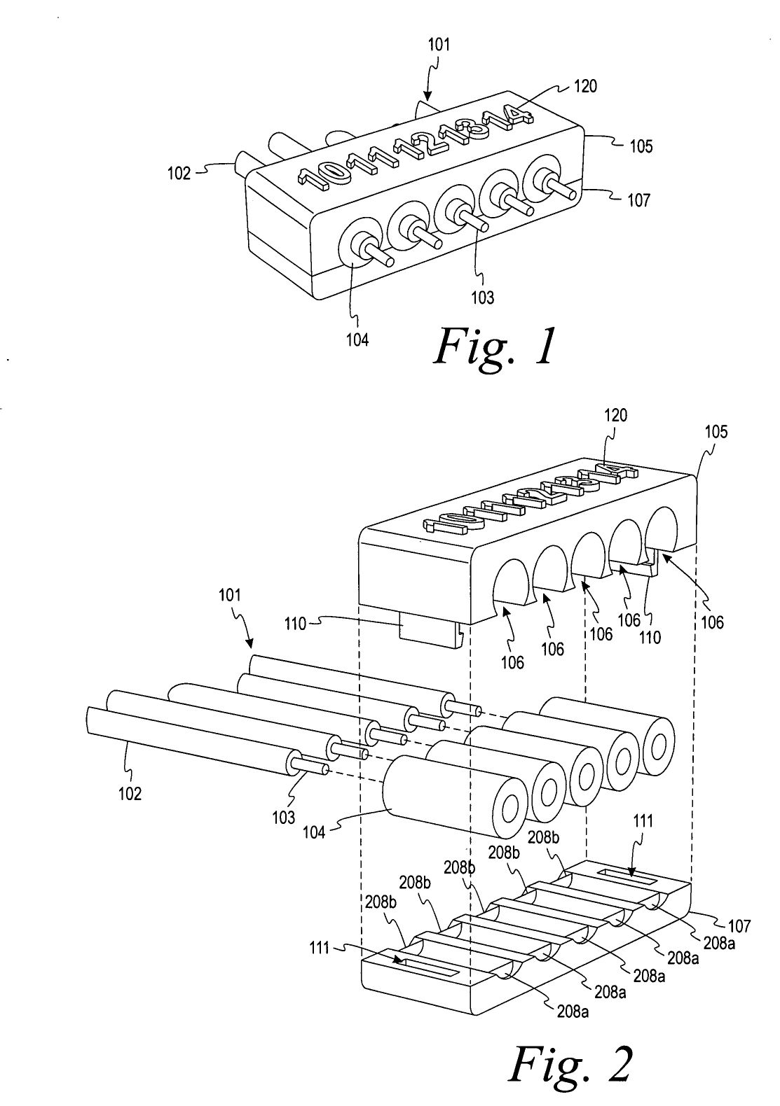

Referring now to the drawings and referring first to FIGS. 1 and 2, a sequencing connection device 100 is two-piece clamp-on device that attaches to a set of insulated wires to be connected to a screw-terminal block. In particular, the connection device 100 prepares a plurality of insulated wires 101 for connection to a terminal block. Any number of wires 101 may be used. Preferably, each of the wires 101 has an outer insulating layer 102 and an inner conductive wire 103.

The connection device 100 includes one or more wire adapters 104, a top shell 105 forming multiple recesses 106 for receiving major portions of the adapters 104, and a bottom shell 107 adapted to mate with the top shell 105 and forming multiple recesses 108 for receiving the lower portions of the adapters 104. Each of the wire adapters 104 is tubular and sized to fit snugly over the insulating layer of one of the wires 101. When the adapters 104 are clamped between the top and bottom shells 105 and 107, the adapters are slightly compressed and held firmly in place within the recesses 106 and 108. As can be seen in FIG. 2, tapered ribs 208a and 208b extend upwardly from the bottom of each recess 208, near the ends of the recess, to bite into the adapters 104 to hold the adapters securely in place. Each of the ribs 208a and 208b is wider at its base than at its top edge, tapering to a sharp edge at the top. The tip of each wire 103 is stripped of the insulation 102 and extends outwardly from the connection device 100 so that an end portion of each wire is ready to be connected to a terminal.

The recesses 106 and 108 of the top and bottom shells 105 and 107, respectively, are sized and shaped to fit tightly around the adapters 104 on the wires 101. The adapters 104 are initially inserted into the recesses 106 of the top shell 105, which encircle more than 180° of the circumference of each adapter 104 and thus prevent the adapters 104 from dropping through the open sides of the recesses 106. After all the desired adapters 104 have been inserted into the top shell 105, the top surface of the bottom shell 107 is advanced toward the open bottom surface of the top shell 105, guiding a pair of clips 110 depending from the top shell 105 into a pair of complementary sockets 111 formed in the upper surface of the bottom shell 107. Shouldered inner surfaces on the clips 110 snap under mating shoulders on the inner surfaces of the sockets 111 to lock the top and bottom shells 105 and 107 together with sufficient pressure on the adapters to hold them in place within the recesses 106 and 108. Thus, the clips 110 and sockets 111 function as fasteners that lock the shells together with the wire adapters in the recesses.

The connection device 100 may also include indicia 120 for identifying each of the wires, such as letters, numbers, symbols, shapes, or colors. In the particular example illustrated in the drawings, the identifying indicia are in the form of raised numbers 10 through 14 on the top surface of the top shell 105. Each of these five numbers identifies the wire inserted into the recess 106 directly beneath that number. The identifying numbers could be formed by recesses in the top surface of the shell 105, rather than raised areas, or the indicia could be provided on the bottom shell 107 instead of, or in addition to, the top shell 105. The use of the identification indicia 120 allows a user to sequentially position the wires 101 in the order in which they are to be connected to a terminal block, and then easily identify each wire using the indicia 120. Identifying means may be used on either the top shell or the bottom shell, as needed. Another form of identifying indicia is to use stick-on overlays created on durable material and inserted into a slightly recessed cavity on either the top or the bottom shell.

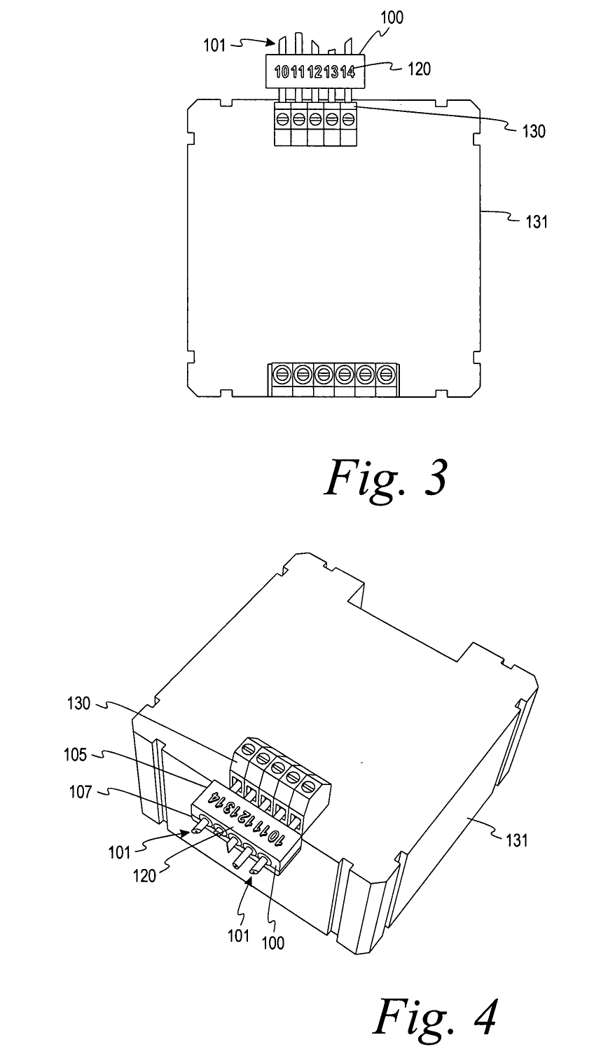

FIGS. 3 and 4 illustrate the use of the connector device 100 in connecting the wires 101 to a screw terminal block 130 on a meter base 131. It can be seen that the five wires 101 held by the connector device 100 are properly positioned for connection to the five screw terminals 132 in the terminal block 130, so that all five wires 101 can be inserted into the terminal block 130 simultaneously by simply advancing the connector device 100 toward the terminal block 130. The wires 101 are also pre-arranged in the proper sequence, so that there is no question, during the actual installation process, about which wire is to be connected to which screw terminal. The five wires are simply inserted into the five screw terminals, followed by tightening of the five terminal screws to complete the connection. Proper connection of the five wires 101 to the terminal block 130 can be easily verified using the identifying indicia 120 on the top surface of the connection device 100.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

1. A connection device for preparing multiple electrical wires for connection to terminals, the connection device comprising:
multiple wire adapters each of which is shaped and dimensioned to fit onto one of said wires,
a top shell forming a multiple recesses each of which is adapted to receive at least a portion of one of the wire adapters,
a bottom shell adapted to enter into engagement with the top shell to secure said wire adapters within said recesses in said top shell when said top and bottom shells are engaged with each other so that movement of said wires and wire adapters relative to said shells is prevented, and
at least one fastener to lock said shells together with said wire adapters in said recesses.

2. The connection device of claim 1 which includes identifying indicia associated with each of said recesses for identifying each of the wires in the wire adapters in said recesses.

3. The connection device of claim 2 in which said identifying indicia is at least one indicia selected from the group consisting of letters, numbers, symbols, shapes and colors.

4. The connection device of claim 2 in which said identifying indicia comprises numbers or letters formed by raised or recessed portion of an exterior surface of at least one of said shells.

5. The connection device of claim 2 in which said identifying indicia comprises stick-on overlays on least one of said shells.

6. The connection device of claim 1 in which said recesses are open on one side to expose portions of said wire adapters for engagement by said bottom shell.

7. The connection device of claim 1 in which said fastener comprises mating clips and sockets formed as integral parts of said shells.

8. The connection device of claim 1 in which wires in said wire adapters are connected to a terminal block.

9. A method of preparing multiple electrical wires for connection to terminals, comprising:
inserting each of said wires into a wire adapter that is shaped and dimensioned to fit onto said wire,
inserting said wire adapters into multiple recesses formed in a first shell,
securing said wire adapters within said recesses in said first shell by engaging said first shell with a second shell that engages said adapters in said recesses to prevent movement of said wire adapters relative to said shells, and
locking said shells together with said wire adapters in said recesses.

10. The method of claim 9 in which at least one of said first and second shells includes identifying indicia associated with each of said recesses for identifying each of the wires in the wire adapters in said recesses.

11. The method of claim 9 in which end portions of said wires project from said shells, and which includes connecting said projecting end portions of said wires to electrical terminals.

12. The method of claim 9 in which said recesses are open on one side to expose portions of said wire adapters for engagement by said second shell.
